(19) United States
(12) Patent Application Publication
(10) Pub. No.: US 2012/0133712 A1
(43) Pub. Date: May 31, 2012

(54) INKJET HEAD AND METHOD OF MANUFACTURING THE INKJET HEAD

(75) Inventor: Masafumi Ohsawa, Shizuoka (JP)

(73) Assignee: TOSHIBA TEC KABUSHIKI KAISHA, Tokyo (JP)

(21) Appl. No.: 13/303,827

(22) Filed: Nov. 23, 2011

(30) Foreign Application Priority Data
Nov. 25, 2010 (JP) 2010-262020

(51) Int. Cl. B41J 2/045; B23P 17/04

(52) U.S. Cl. 347/71; 29/890.1

(57) ABSTRACT

An inkjet head includes an actuator row fixed to a substrate. Plural concave grooves formed in the actuator row at intervals along a row direction serve as pressure chambers. The inkjet head ejects ink in the pressure chambers from nozzles facing the pressure chambers. The actuator row includes a piezoelectric member formed in a convex shape including a trapezoidal section forming sidewalls of the pressure chambers viewed in a latitudinal direction and a flat section projecting sideways from a side of the trapezoidal section. The flat section fits in a recessed section formed in the substrate.

### CROSS-REFERENCE TO RELATED APPLICATION

This application is based upon and claims the benefit of the prior Japanese Patent Application No. 2010-262020 filed on Nov. 25, 2010, the entire contents of which are incorporated herein by reference.

### FIELD

Embodiments described herein relate generally to an inkjet head and a method of manufacturing the inkjet head.

### BACKGROUND

In a method of manufacturing a fluid ejecting device used in an inkjet printer, first, a supply port and a discharge port are formed in a substrate, which is formed of a ceramics sheet, by press molding. Subsequently, the substrate is baked. A pair of piezoelectric members is bonded to the substrate. Grinding or cutting is applied to corners of the piezoelectric member (taper grinding). A large number of concave grooves are formed in the piezoelectric members subjected to the taper grinding. The large number of grooves serves as pressure chambers.

Thereafter, a metal film is formed on surfaces of the piezoelectric members and a surface of the substrate including inner surfaces of the large number of concave grooves. Then electrodes are formed on the inner surfaces of the concave grooves of the substrate by laser patterning. Finally, electric wires conductive to the electrodes on the substrate are formed.

Sides of the piezoelectric members extending from ends of bottom surfaces of the concave grooves are inclined by the taper grinding. The metal film is also applied to the inclined sides of the piezoelectric members. The electric wires formed on the substrate and the electrodes formed on the inner surfaces of the concave grooves are made conductive.

The metal film on end faces of sidewalls that partition the large number of concave grooves and extend along a longitudinal direction of the grooves and the metal film on the substrate on extended lines of the sidewalls are cut off by laser machining. The metal film formed in the centers in the width direction of the bottom surfaces of the concave grooves is cut off by laser machining. Consequently, the electrodes insulated from one another are formed on the opposed inner surfaces of the concave grooves. The electric wires are respectively connected to these electrodes.

A driving voltage is applied to the electrodes formed on both surfaces of the sidewalls, whereby the sidewalls are bent to change the capacity of the pressure chambers.

### DESCRIPTION OF THE DRAWINGS

FIG. 1 is a perspective view for depicting a procedure for forming an actuator of an inkjet head according to an embodiment;

FIG. 2 is an external perspective view of a piezoelectric member secondary workpiece obtained by forming concave grooves in a piezoelectric member primary workpiece shown in FIG. 1;

FIG. 3 is an enlarged perspective view of the concave grooves shown in FIG. 2;

FIG. 4 is an external perspective view of a piezoelectric member tertiary workpiece obtained by forming an electrode film on the piezoelectric member secondary workpiece shown in FIG. 2;

FIG. 5 is a partially enlarged view of an actuator row obtained by applying laser patterning to the piezoelectric member tertiary workpiece shown in FIG. 4;

FIG. 6 is a perspective view of the external appearance of the inkjet head;

FIG. 7 is a cross-sectional diagram for explaining that sidewalls of the piezoelectric member secondary workpiece shown in FIGS. 2 and 3 are excellent in shock resistance; and

FIG. 8 is a cross-sectional diagram for explaining that sidewalls of a piezoelectric member secondary workpiece formed in a trapezoidal shape is poor in shock resistance.

### DETAILED DESCRIPTION

According to an embodiment, an inkjet head includes a substrate. A recessed section can be provided in the substrate. A piezoelectric member can be stacked and fixed on the recessed section of the substrate so that it projects from a surface of the substrate. The piezoelectric member has a flat section on both sides thereof coplanar with the surface of the substrate. The piezoelectric member has a trapezoidal section obliquely protruding above the surface of the substrate in oblique directions. Pressure chambers for actuators including a plurality of concave grooves and sidewalls at a predetermined pitch are provided in the trapezoidal section.

An embodiment is explained below with reference to the accompanying drawings. A side-shooter type inkjet head of a shear wall system is explained as an example of an inkjet head according to this embodiment. However, the aspects of the inkjet head are applicable to other types of inkjet heads.

The principle of ink ejection of the inkjet head is explained as follows. Two tabular piezoelectric members polarized in the thickness direction are bonded together by an adhesive with polarization directions of the piezoelectric members set in opposite directions. Plural grooves are formed at a predetermined interval or pitch in the bonded two piezoelectric members. The plural grooves serve as pressure chambers. Electrodes are respectively formed in the pressure chambers. A driving voltage is applied to the electrodes, whereby sidewalls (the piezoelectric members) that partition the pressure chambers from one another are deformed and pressure for ink ejection is applied to the pressure chambers. Consequently, ink droplets are ejected from nozzles that communicate with the pressure chambers.

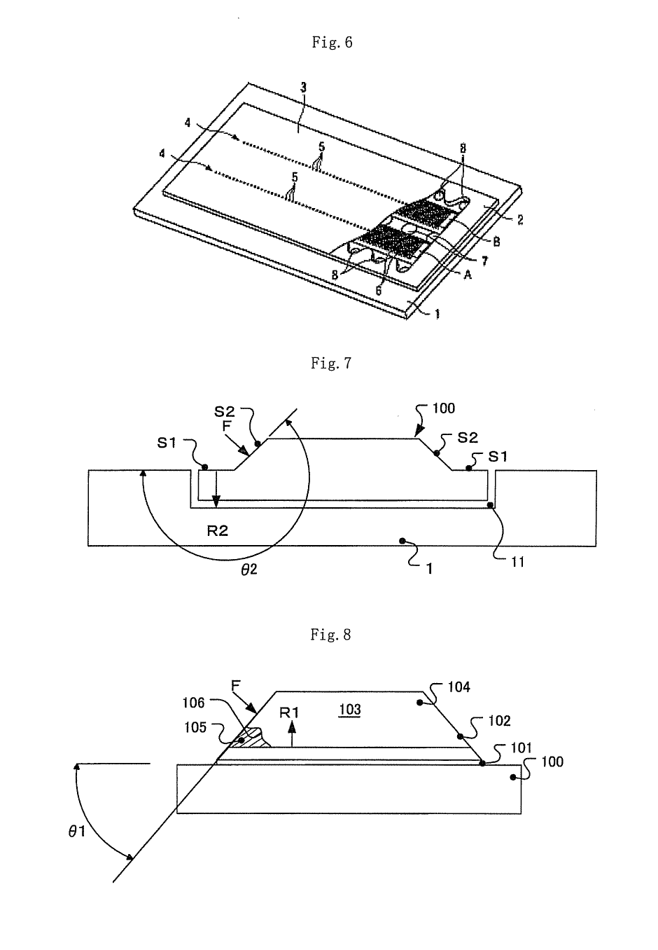

As shown in FIG. 6, an actuator row A and an actuator row B are formed on a surface of a tabular substrate (also referred to as a base substrate) 1 formed of alumina, for example, which is a low dielectric constant member. A frame member 2 surrounding the actuator row A and the actuator row B is mounted on the substrate 1. The frame member 2 is a nozzle plate (also referred to as an orifice plate) 3. The nozzle plate 3 is formed of, for example, a square polyimide film and has a pair of nozzle rows 4. Plural nozzles 5 are arrayed in a row in each of the pair of nozzle rows 4.

Each of the actuator rows A and B is formed by bonding two piezoelectric members of, for example, PZT (lead zirconate titanate) together vertically with polarization directions of the piezoelectric members set opposed to each other. The actuator rows A and B are respectively arrayed along the pair of nozzle rows 4. The surface of the substrate 1 is cut in a concave shape to form plural grooves along a direction orthogonal to the pair of nozzle rows 4. Plural concave grooves are formed at a fixed interval in a longitudinal direction of the substrate 1. The plural concave grooves are plural pressure chambers 6 and have approximately the same width.

The plural pressure chambers 6 are located in positions corresponding to the plural nozzles 5 of the nozzle plate 3. A voltage is applied to a columnar portion (the two piezoelectric members) between the pressure chambers 6 adjacent to each other, whereby the columnar portion is deformed. Pressure for ink ejection is applied to the pressure chambers 6 by the deformation and ink is ejected from the nozzles 5.

Electrodes for applying the voltage are formed on sidewalls of the concave grooves that respectively partition the pressure chambers 6. As a method of forming the electrodes formed on the pressure chambers 6 and the substrate 1, the following method explained below can be exemplified.

A metal film is formed on the surface of the substrate 1 by electroless nickel plating and electrolytic gold plating. The metal film is burned off or etched by a laser beam and removed (so-called subtract method), whereby remaining portions of the metal film are formed as the electrodes.

On the other hand, in the substrate 1, plural circular ink inlets 7 are provided between the actuator rows A and B. Further, in the substrate 1, plural ink outlets 8 are provided on the outer sides of the actuator rows A and B. The ink inlets 7 and the ink outlets 8 are formed in the substrate 1 in advance, for example, by die molding or machining of alumina. In this state, bonding of piezoelectric members P having a rectangular parallelepiped shape before formation of the actuator rows A and B is performed. Thereafter, cutting of both sides of the piezoelectric members P is performed.

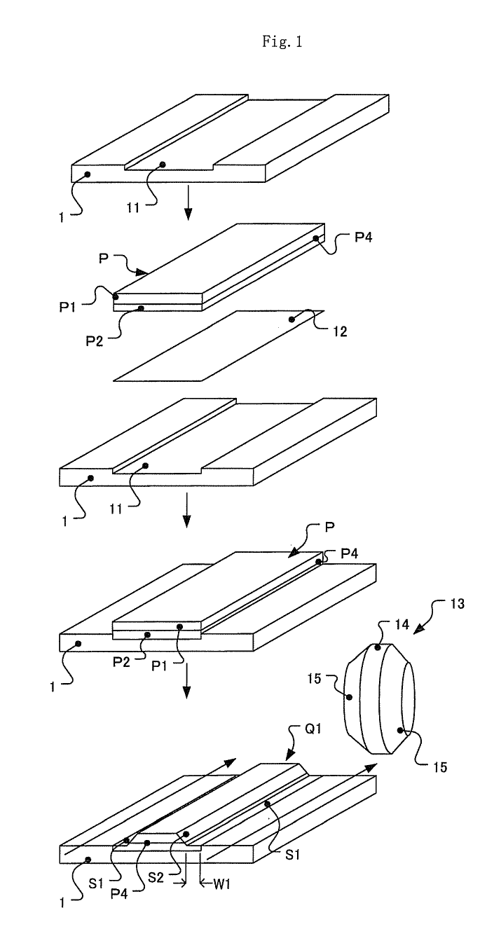

FIG. 1 is a diagram for explaining the bonding and the cutting. The piezoelectric members P for the actuator rows A and B are arranged in two rows in parallel on the substrate 1. However, in FIG. 1, only the piezoelectric member P for the actuator row A is shown for brevity. The piezoelectric member P for the actuator row B is not shown.

The piezoelectric member P for forming the actuator row A is formed by bonding a first piezoelectric body P1 and a second piezoelectric body P2 of, for example, PZT (lead zirconate titanate) together with polarization directions of the piezoelectric bodies set in opposite directions. As an exemplary adhesive, a thermosetting adhesive made of epoxy resin or the like is used. A lower surface of the first piezoelectric body P1 and an upper surface of the second piezoelectric body P2 are bonded together.

A recessed section 11 on which the piezoelectric member P is stacked is formed in the substrate 1. A thermosetting adhesive 12 made of epoxy resin or the like is applied to the recessed section 11. A lower part of the piezoelectric member P is stacked on the recessed section 11 and bonded and fixed. Consequently, a part of the second piezoelectric body P2 of the piezoelectric member P is embedded in the recessed section 11. An upper part of the second piezoelectric body P2 and the first piezoelectric body P1 project further upward than the surface of the substrate 1. In the piezoelectric member P, a section projecting from the surface of the substrate 1 is a piezoelectric member projecting section P3 (P3 is not shown in FIG. 1).

In a state in which the second piezoelectric body P2 of the piezoelectric member P is fixedly attached to the recessed section 11 of the substrate 1, the substrate 1 on both sides of the piezoelectric member projecting section P3 is ground along the longitudinal direction by a grinder 13. Consequently, flat sections S1 obtained by grinding both the sides of the piezoelectric member projecting section P3 flat by the length of width W1 and slope sections S2 obtained by obliquely grinding both the sides of the piezoelectric member projecting section P3 are formed. As a result, a piezoelectric member primary workpiece Q1 having a shape in which the flat sections S1 are projected to both sides in the width direction of a trapezoidal section viewed from the longitudinal direction is formed. Upper surfaces of the flat sections S1 are set in the same level as the surface of the substrate 1. The flat sections S1 are the second piezoelectric body P2.

The grinder 13 includes a first grinding section 14, an outer circumferential surface of which is a flat surface, and second grinding sections 15 having a taper shape formed on both sides of the first grinding section 14. The grinder 13 is rotated, whereby the flat sections S1 of the piezoelectric member projecting section P3 are ground by the first grinding section 14 and the slope sections S2 of the piezoelectric member projecting section P3 are simultaneously formed by the second grinding sections 15.

If the grinder 13 is arranged between the piezoelectric members P arranged in two rows corresponding to the actuator rows A and B to grind the substrate 1, one flat section S1 and two slope sections S2 can be simultaneously formed between the two piezoelectric members P.

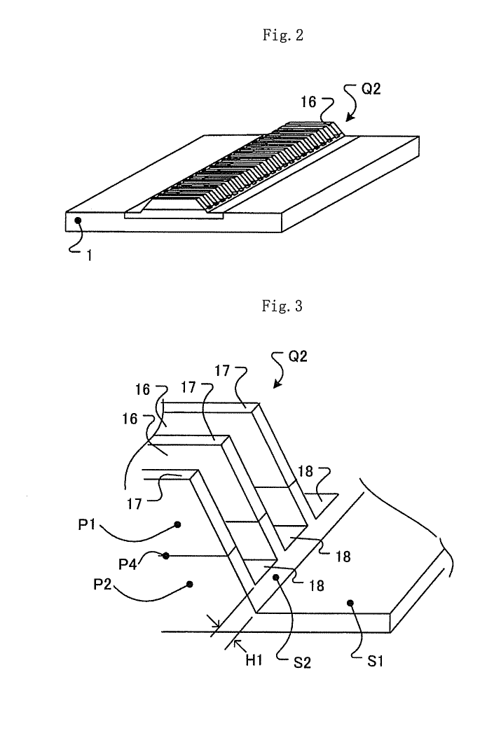

FIG. 2 is a diagram of a state in which a large number of concave grooves 16, which serve as the pressure chambers 6, are formed in the piezoelectric member primary workpiece Q1 and a piezoelectric member secondary workpiece Q2 is molded. FIG. 3 is an enlarged view of the concave grooves 16. In FIGS. 2 and 3, in the piezoelectric member primary workpiece Q1 formed in a projected section of a trapezoid, the plural concave grooves 16 are formed by cutting using, for example, a diamond wheel for machining. The plural concave grooves 16 are formed at equal intervals while being shifted by a half pitch from one another along the longitudinal direction of the substrate 1 and mold the piezoelectric member secondary workpiece Q2. In the piezoelectric member primary workpiece Q1 of the actuator row B, the plural concave grooves 16 are formed in the same manner.

The large number of concave grooves 16 is partitioned by sidewalls 17. Bottom surfaces 18 of the concave grooves 16 are formed in a position at height H1 from the surfaces of the flat sections S1. The concave grooves 16 are grooves deeper than the position of a bonding surface P4 of the first piezoelectric body P1 and the second piezoelectric body P2. If the concave grooves 16 are formed at, for example, width of 80 and pitch width in the longitudinal direction of 169 μm, the thickness of the sidewalls 17 partitioning the concave grooves 16 is extremely small at 89 μm.

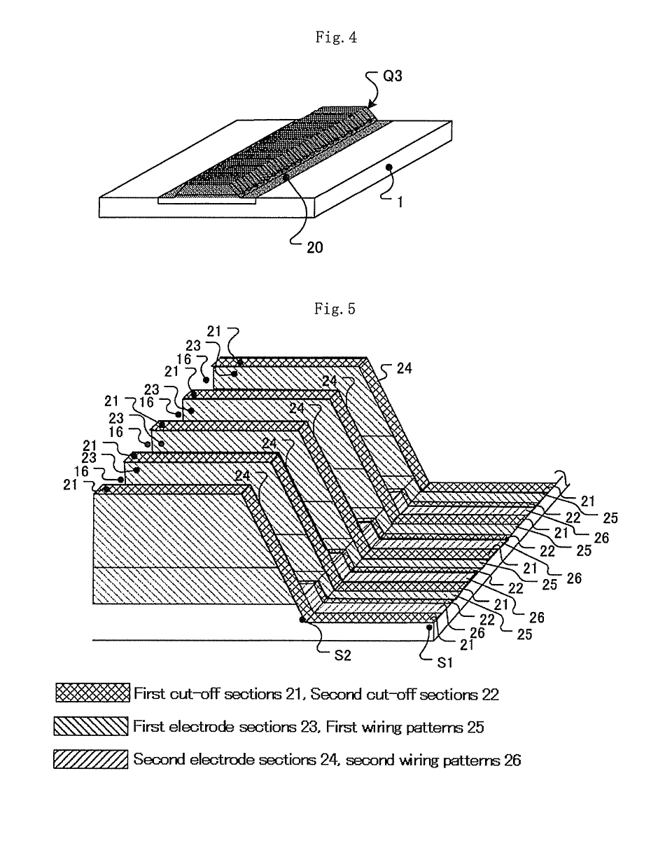

Electrode formation processing is applied to the piezoelectric member second workpiece Q2 molded as explained above. As shown in FIG. 4, in the electrode formation processing, first, a metal film 20 is formed on a surface of the piezoelectric member secondary workpiece Q2 by, for example, electroless plating to obtain a piezoelectric member tertiary workpiece Q3. In this embodiment, since wiring patterns can be formed on the flat sections 51 (the second piezoelectric body P2), it is unnecessary to form a wiring pattern on the substrate 1.

Subsequently, a laser beam is irradiated on the metal film 20 formed on the piezoelectric member tertiary workpiece Q3 to remove unnecessary portions of the metal film 20. The actuator row A is formed by this electrode separation and removal (laser patterning). The actuator row B not shown in the figure is formed in the same manner. As a process before the laser patterning, the electrodes on the surface of the substrate 1 are smoothed. Specifically, the laser beam is irradiated on a formation planning region for the electrodes to prevent the metal film 20 from being deposited in the depth direction of the substrate 1.

The metal film 20 is formed on inner surfaces of the sidewalls 17 of the concave grooves 16, the bottom surfaces 18, end faces of the sidewalls 17 (upper end surfaces and inclined end faces forming the external shape of the trapezoid), the surfaces of the flat sections S1, and surfaces of the slope sections S2 between the bottom surfaces 18 and the flat sections S1. If wiring patterns are formed on the surface of the substrate 1, the metal film 20 is formed on the surface of the substrate 1 as well.

The metal film formed on the flat sections S1 is used as wiring patterns. The metal film formed on the inner surfaces of the sidewalls 17 is used as electrode sections. Therefore, conditions for the laser patterning satisfy the following three points: (1) the electrode sections formed on both the inner surfaces of the sidewalls 17 are made non-conductive; (2) in the concave grooves 16, the electrodes formed on the inner surfaces of the opposed sidewalls 17 are made non-conductive; and (3) wiring patterns on the flat sections S1 and the slope sections S2 are connected to the electrode sections formed on the inner surfaces of the sidewalls 17.

FIG. 5 is an enlarged view for explaining a part of the laser patterning. As cut-off sections, there are first cut-off sections 21 and second cut-off sections 22. The first cut-off sections 21 cut off the end faces of the sidewalls 17 and extended lines along the end faces of the sidewalls 17. The second cut-off sections 22 cut off the centers in the width direction of the bottom surfaces 18 of the concave grooves 16 and extended lines along the centers in the width direction.

The first cut-off sections 21 make first electrode sections 23 and second electrode sections 24 formed on both the surfaces of the sidewalls 17 non-conductive. The second cut-off sections 22 are formed on the bottom surfaces 18 of the concave grooves 16 such that the meal film remains on both sides of the second cut-off sections 22. Therefore, the first electrode sections 23 and first wiring patterns 25 are connected and the second electrode sections 24 and second wiring patterns 26 are connected. The cut-off of the metal film 20 shown in the figure is an example. The embodiment is not limited to this particular pattern.

Examples of methods of forming the metal film 20, include sputtering methods, CVD methods, PVD methods, plating methods, and the like. As a method for making it possible to surely form the metal film 20 to the inside of the concave grooves 16, an electroless plating method is desirable.

An example of a cross-section of a piezoelectric member secondary workpiece formed on a flat substrate is shown in FIG. 8. A rectangular parallelepiped piezoelectric member 102 is bonded and fixed on a flat substrate 100 via an adhesive 101. In other words, the piezoelectric member P obliquely protrudes from the substrate surface. Cutting is applied to both sides of the piezoelectric member 102 to mold the piezoelectric member 102 in a trapezoidal shape. Concave grooves 103 (103 is not shown in FIG. 8) are formed at a predetermined pitch in the piezoelectric member 102. In such a piezoelectric member secondary workpiece, if an impact is applied to sidewalls 104, which partition the concave grooves 103, by a finger, a tool, or the like by mistake during work for forming a metal film and the like, the sidewalls 104 could be partially chipped. In this secondary workpiece, an angle θ1 formed by bottom surfaces of the concave grooves 103 and slopes of the sidewalls 104 is an acute angle. Therefore, if an external force F is applied to the slopes of the sidewalls 104, reaction R1 of the external force F is applied to the sidewalls 104. The sidewalls 104 close to a portion where the external force F is applied are cracked and partially chipped. If molding of a metal film is performed in a state in which the sidewalls 104 are chipped, a metal film is formed on inner peripheral end faces 106 of chipped portions 105. Therefore, metal films on both sides of the sidewalls 104 are conductive to the chipped portions 105 via the metal film. Even if the laser patterning is performed in this state, the inner peripheral end faces of the chipped portions 105 cannot be cut off. Therefore, electrode sections formed on both the sides of the sidewalls 104 remain conductive and a defective product is manufactured.

On the other hand, as shown in FIG. 7, in the piezoelectric member primary workpiece Q1 in this embodiment, the sidewalls 17 are joined to the slope sections S2 to form the flat sections S1. An angle θ2 formed from the slope sections S2 to the surfaces of the flat sections S1 is an obtuse angle. Therefore, even if the external force F is applied to the slop sections S2, since a reaction R2 occurs in the flat sections S1, large force is not applied to the sidewalls 17. Therefore, occurrence of chipping is substantially reduced and/or eliminated. An electrode film that cannot be removed by the laser patterning is present. Conduction of the first electrode sections 23 and the second electrode sections 24 formed on both the sides of the sidewalls 17 is not maintained.

The present invention is not limited to the embodiment and can be variously modified without departing from the spirit of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
a substrate;
a recessed section provided in the substrate;
a piezoelectric member stacked and fixed on the recessed section of the substrate and projecting from a surface of the substrate;
the piezoelectric member having a flat section on both sides thereof coplanar with the surface of the substrate;
the piezoelectric member a trapezoidal section obliquely protruding above the surface of the substrate in oblique directions; and
pressure chambers for actuators including a plurality of concave grooves and sidewalls at a predetermined pitch in the trapezoidal section.

2. The inkjet head according to claim 1, wherein wiring patterns formed on a surface of the flat section and electrode sections formed on the sidewalls of the trapezoidal section are connected.

3. The inkjet head according to claim 2, wherein the wiring patterns connected to the electrode sections on the sidewalls are formed by cutting off centers in a width direction of bottom surfaces of the plurality of concave grooves and the flat section along the centers in the width direction.

4. The inkjet head according to claim 1, wherein
the piezoelectric member is formed by bonding a first piezoelectric body and a second piezoelectric body of lead zirconate titanate with polarization directions of the piezoelectric bodies set in opposite directions, and
the entire first piezoelectric body and a part of the second piezoelectric body project from the surface of the substrate and are fixed in the recessed section of the substrate.

5. A method of manufacturing an inkjet head comprising:
stacking and fixing a piezoelectric member on a recessed section of a substrate in a state in which the piezoelectric member projects from a surface of the substrate;
grinding both sides of the piezoelectric member to height of the surface of the substrate to form a flat section;
grinding both the sides of the piezoelectric member in oblique directions to form a trapezoidal section; and
grinding the trapezoidal section at equal intervals to form pressure chambers for actuators including a large number of concave grooves and sidewalls.

6. The method according to claim 5, further comprising:
applying a metal film to the flat section and the large number of concave grooves and sidewalls; and
cutting off end faces of the large number of sidewalls and the flat section along the end faces of the sidewalls to form electrode sections on the sidewalls.

7. The method according to claim 5, further comprising:
applying a metal film to the flat section and the large number of concave grooves and sidewalls; and
cutting off centers in a width direction of bottom surfaces of the large number of concave grooves and the flat section along the centers in the width direction to form wiring patterns connected to electrode sections on the sidewalls.

8. The method according to claim 5, wherein
the piezoelectric member is formed by bonding a first piezoelectric body and a second piezoelectric body of lead zirconate titanate with polarization directions of the piezoelectric bodies set in opposite directions, and
the entire first piezoelectric body and a part of the second piezoelectric body project from the surface of the substrate and are fixed in the recessed section of the substrate.
